(19) United States
(12) Patent Application Publication
(10) Pub. No.: US 2007/0248813 A1
(43) Pub. Date: Oct. 25, 2007

(54) Imaging member having styrene

(75) Inventors: Jin Wu, Webster, NY (US); Liang-bih Lin, Rochester, NY (US); Daniel V. Levy, Rochester, NY (US); Marc J. Livecchi, Rochester, NY (US)

Correspondence Address: Carolyn S. Lu, Suite 2800, 725 S. Figueroa Street, Los Angeles, CA, 90017, US

(73) Assignee: Xerox Corporation, Stamford, CT (US)

(21) Appl. No.: 11/410,593

(22) Filed: Apr. 25, 2006

(51) Int. Cl. B32B 27/30; B32B 27/42; B32B 27/20

(52) U.S. Cl. 428/337; 428/522; 428/524

(57) ABSTRACT

The presently disclosed embodiments relate in general to electrophotographic imaging members, such as layered photoreceptor structures, and processes for making and using the same. More particularly, the embodiments pertain to a photoreceptor undercoat layer that includes styrene acrylic copolymers and aminoplast resins to improve image quality.

### BACKGROUND

Herein disclosed are imaging members, such as layered photoreceptor devices, and processes for making and using the same. The imaging members can be used in electrophotographic, electrostatographic, xerographic and like devices, including printers, copiers, scanners, facsimiles, and including digital, image-on-image, and like devices. More particularly, the embodiments pertain to an imaging member or a photoreceptor that incorporates specific molecules, namely styrene acrylic copolymers and aminoplast resins, to improve image quality.

Electrophotographic imaging members, e.g., photoreceptors, typically include a photoconductive layer formed on an electrically conductive substrate. The photoconductive layer is an insulator in the substantial absence of light so that electric charges are retained on its surface. Upon exposure to light, the charge is dissipated.

In electrophotography, also known as Xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. The radiation selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

An electrophotographic imaging member may be provided in a number of forms. For example, the imaging member may be a homogeneous layer of a single material such as vitreous selenium or it may be a composite layer containing a photoconductor and another material. In addition, the imaging member may be layered. These layers can be in any order, and sometimes can be combined in a single or mixed layer.

The demand for improved print quality in xerographic reproduction is increasing, especially with the advent of color. Common print quality issues are strongly dependent on the quality of the undercoat layer (UCL). Conventional materials used for the undercoat or blocking layer have been problematic. In certain situations, a thicker undercoat is desirable, but the thickness of the material used for the undercoat layer is limited by the inefficient transport of the photo-injected electrons from the generator layer to the substrate. If the undercoat layer is too thin, then incomplete coverage of the substrate results due to wetting problems on localized unclean substrate surface areas. The incomplete coverage produces pin holes which can, in turn, produce print defects such as charge deficient spots (CDS) and bias charge roll (BCR) leakage breakdown. Other problems include “ghosting,” which is thought to result from the accumulation of charge somewhere in the photoreceptor. Removing trapped electrons and holes residing in the imaging members is the key to preventing ghosting. During the exposure and development stages of xerographic cycles, the trapped electrons are mainly at or near the interface between charge generating layer (CGL) and undercoating layer (UCL) and holes mainly at or near the interface between charge generating layer and charge transport layer (CTL). The trapped charges can migrate according to the electric field during the transfer stage, where the electrons can move from the interface of CGUUCL to CTUCGL or the holes from CTUCGL to CGUUCL and became deep traps that are no longer mobile. Consequently, when a sequential image is printed, the accumulated charge results in image density changes in the current printed image that reveals the previously printed image. Thus, there is a need, which the present embodiments address, for a way to minimize or eliminate charge accumulation in photoreceptors, without sacrificing the desired thickness of the undercoat layer.

The terms “charge blocking layer” and “blocking layer” are generally used interchangeably with the phrase “undercoat layer.”

Conventional photoreceptors and their materials are disclosed in Katayama et al., U.S. Pat. No. 5,489,496; Yashiki, U.S. Pat. No. 4,579,801; Yashiki, U.S. Pat. No. 4,518,669; Seki et al., U.S. Pat. No. 4,775,605; Kawahara, U.S. Pat. No. 5,656,407; Markovics et al., U.S. Pat. No. 5,641,599; Monbaliu et al., U.S. Pat. No. 5,344,734; Terrell et al., U.S. Pat. No. 5,721,080; and Yoshihara, U.S. Pat. No. 5,017,449, which are herein all incorporated by reference.

More recent photoreceptors are disclosed in Fuller et al., U.S. Pat. No. 6,200,716; Maty et al., U.S. Pat. No. 6,180,309; and Dinh et al., U.S. Pat. No. 6,207,334, which are all herein incorporated by reference.

Conventional undercoat or charge blocking layers are also disclosed in U.S. Pat. No. 4,464,450; U.S. Pat. No. 5,449,573; U.S. Pat. No. 5,385,796; and Obinata et al, U.S. Pat. No. 5,928,824, which are all herein incorporated by reference.

### SUMMARY

According to embodiments illustrated herein, there is provided a way in which print quality is improved, for example, ghosting is minimized or substantially eliminated in images printed in systems with high transfer current.

In one embodiment, there is provided an electrophotographic imaging member, comprising a substrate, an undercoat layer disposed on the substrate, wherein the undercoat layer further comprises a styrene acrylic copolymer, an aminoplast resin, and a metal oxide dispersed therein; and at least one imaging layer formed on the undercoat layer.

Embodiments also provide an electrophotographic imaging member, comprising a substrate, an undercoat layer disposed on the substrate, wherein the undercoat layer further comprises a styrene acrylic copolymer, a melamine-formaldehyde resin, and titanium oxide dispersed therein, and a charge transport layer formed on the undercoat layer.

In another embodiment, there is provided an image forming apparatus for forming images on a recording medium comprising a) an electrophotographic imaging member having a charge retentive-surface to receive an electrostatic latent image thereon, wherein the electrophotographic imaging member comprises a substrate, an undercoat layer disposed on the substrate, wherein the undercoat layer further comprises a styrene acrylic copolymer, an aminoplast resin, and a metal oxide dispersed therein, and at least one imaging layer formed on the undercoat layer, b) a development component adjacent to the charge-retentive surface for applying a developer material to the charge-retentive surface to develop the electrostatic latent image to form a developed image on the charge-retentive surface, c) a transfer component adjacent to the charge-retentive surface for transferring the developed image from the charge-retentive surface to a copy substrate, and d) a fusing component adjacent to the copy substrate for fusing the developed image to the copy substrate.

### BRIEF DESCRIPTION OF THE DRAWINGS

A detailed description of embodiments disclosed herein will be made with reference to the accompanying drawing, wherein like numerals designate corresponding parts in the figures.

FIG. 1 is a cross-sectional view schematically showing an electrophotographic imaging member according to an embodiment disclosed herein.

### DETAILED DESCRIPTION

In the following description, it is understood that other embodiments may be utilized and structural and operational changes may be made without departure from the scope of the present embodiments disclosed herein.

The present embodiments relate to a photoreceptor having an undercoat layer which incorporates an additive to the formulation that helps reduce, and preferably substantially eliminates, specific printing defects in the print images.

According to embodiments, an electrophotographic imaging member is provided, which generally comprises at least a substrate layer, an undercoat layer, and an imaging layer. The undercoating layer is generally located between the substrate and the imaging layer, although additional layers may be present and located between these layers. The imaging member may also include a charge generating layer and a charge transport layer. This imaging member can be employed in the imaging process of electrophotography, where the surface of an electrophotographic plate, drum, belt or the like (imaging member or photoreceptor) containing a photoconductive insulating layer on a conductive layer is first uniformly electro statically charged. The imaging member is then exposed to a pattern of activating electromagnetic radiation, such as light. The radiation selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

Thick undercoat layers are desirable for photoreceptors due to their life extension and carbon fiber resistance. Furthermore, thicker undercoat layers make it possible to use less costly substrates in the photoreceptors. Such thick undercoat layers have been developed, such as one developed by Xerox Corporation and disclosed in U.S. patent application Ser. No. 10/942,277, filed Sep. 16, 2004, entitled “Photoconductive Imaging Members,” which is hereby incorporated by reference. However, due to insufficient electron conductivity in dry and cold environments, the residual potential in conditions known as “J zone” (10% room humidity and 70o F.) is unacceptably high (e.g., >150V) when the undercoat layer is thicker than 15 μm.

Common print quality issues are strongly dependent on the quality of the undercoat layer. Conventional materials used for the undercoat or blocking layer have been problematic because print quality issues are strongly dependent on the quality of the undercoat layer. For example, charge deficient spots and bias charge roll leakage breakdown are problems the commonly occur. Another problem is “ghosting,” which is thought to result from the accumulation of charge somewhere in the photoreceptor. Consequently, when a sequential image is printed, the accumulated charge results in image density changes in the current printed image that reveals the previously printed image.

There have been formulations developed for undercoat layers that, while suitable for their intended purpose, do not address the ghosting effect problem. To alleviate the problems associated with charge block layer thickness and high transfer currents, the incorporation of specific resins to a formulation containing titanium oxide (TiO₂) has shown to substantially reduce and preferably eliminate ghosting failure in xerographic reproductions. One such formulation is described in U.S. patent application entitled “Improved Imaging Member,” filed Apr. 13, 2006, to Lin et al (Attorney docket No. 2006006-350393).

The present embodiments disclose that thick undercoat layers that incorporate styrene acrylic copolymers into the formulations exhibit even lower ghosting levels than previously achieved. Incorporation of styrene units into the formulation help provide the undercoat layer with lower ghosting as well as more rigidity and resistance than, for example, an undercoat layer that incorporates only acrylic polymers. A rigid undercoat layer is more desirable as such a layer is more resistant to carbon fiber penetration than other conventional, softer undercoat layers. Due to a more rigid styrene unit, styrene acrylic copolymers demonstrate a higher “glass transition temperature (T_{g})” than acrylic polymers. T_{g} is the temperature at which an amorphous polymer (or the amorphous regions in a partially crystalline polymer) changes from a hard and relatively brittle condition to a viscous or rubbery condition.

In various embodiments, the styrene acrylic copolymers are used with different aminoplast resins and different metal oxides. Styrene acrylic copolymers or styrene acrylics are copolymers of styrene, derivatives of acrylic and methacrylic acid including acrylic and methacrylic esters and compounds containing nitrile and amide groups, and other optional monomers. Said acrylic esters can be selected from a group consisting of n-alkyl acrylates such as methyl, ethyl, propyl, butyl, pebtyl, hexyl, heptyl, octyl, nonyl, decyl, dodecyl, tetradecyl, or hexadecyl acrylate; secondary and branched-chain alkyl acrylates such as isopropyl, isobutyl, sec-butyl, 2-ethylhexyl, or 2-ethylbutyl acrylate; olefinic acrylates such as allyl, 2-methylallyl, furfuryl, or 2-butenyl acrylate; aminoalkyl acrylates such as 2-(dimethylamino)ethyl, 2-(diethylamino)ethyl, 2-(dibutylamino)ethyl, or 3-(diethylamino)propyl acrylate; ether acrylates such as 2-methoxyethyl, 2-ethoxyethyl, tetrahydrofurfuryl, or 2-butoxyethyl acrylate; cycloalkyl acrylates such as cyclohexyl, 4-methylcyclohexyl, or 3,3,5-trimethylcyclohexyl acrylate; halogenated alkyl acrylates such as 2-bromoethyl, 2-chloroethyl, or 2,3-dibromopropyl acrylate; glycol acrylates and diacrylates such as ethylene glycol, propylene glycol, 1,3-propanediol, 1,4-butanediol, diethylene glycol, 1,5-pentanediol, triethylene glycol, dipropylene glycol, 2,5-hexanediol, 2,2-diethyl-1,3-propanediol, 2-ethyl-1,3-hexanediol, or 1,10-decanediol acrylate and diacrylate. Said methacrylic esters can be selected from a group consisting of alkyl methacrylates such as methyl, ethyl, propyl, isopropyl, n-nutyl, isobutyl, sec-butyl, t-butyl, n-hexyl, n-octyl, isooctyl, 2-ethylhexyl, n-decyl, or tetradecyl methacylate; unsaturated alkyl methacrylates such as vinyl, allyl, oleyl, or 2-propynyl methacrylate; cycloalkyl methacrylates such as cyclohexyl, 1-methylcyclohexyl, 3-vinylcyclohexyl, 3,3,5-trimethylcyclohexyl, bornyl, isobornyl, or cyclopenta-2,4-dienyl methacrylate; aryl methacrylates such as phenyl, benzyl, or nonylphenyl methacrylate; hydroxyalkyl methacrylates such as 2-hydroxyethyl, 2-hydroxypropyl, 3-hydroxypropyl, or 3,4-dihydroxybutyl methacrylate; ether methacrylates such as methoxymethyl, ethoxymethyl, 2-ethoxyethoxymethyl, allyloxymethyl, benzyloxymethyl, cyclohexyloxymethyl, 1-ethoxyethyl, 2-ethoxyethyl, 2-butoxyethyl, 1-methyl-(2-vinyloxy)ethyl, methoxymethoxyethyl, methoxyethoxyethyl, vinyloxyethoxyethyl, 1-butoxypropyl, 1-ethoxybutyl, tetrahydrofurfuryl, or furfuryl methacrylate; oxiranyl methacrylates such as glycidyl, 2,3-epoxybutyl, 3,4-epoxybutyl, 2,3-epoxycyclohexyl, or 10,11-epoxyundecyl methacrylate; aminoalkyl methacrylates such as 2-dimethylaminoethyl, 2-diethylaminoethyl, 2-t-octylaminoethyl, N,N-dibutylaminoethyl, 3-diethylaminopropyl, 7-amino-3,4-dimethyloctyl, N-methylformamidoethyl, or 2-ureidoethyl methacrylate; glycol dimethacrylates such as methylene, ethylene glycol, 1,2-propanediol, 1,3-butanediol, 1,4-butanediol, 2,5-dimethyl-1,6-hexanediol, 1,10-decanediol, diethylene glycol, or triethylene glycol dimethacrylate; trimethacrylates such as trimethylolpropane trimethacrylate; carbonyl-containing methacrylates such as carboxymethyl, 2-carboxyethyl, acetonyl, oxazolidinylethyl, N-(2-methacryloyloxyethyl)-2-pyrrolidinone, N-methacryloyl-2-pyrrolidinone, N-(metharyloyloxy)formamide, N-methacryloylmorpholine, or tris(2-methacryloxyethyl)amine methacrylate; other nitrogen-containing methacrylates such as 2-methacryloyloxyethylmethyl cyanamide, methacryloyloxyethyltrimethylammonium chloride, N-(methacryloyloxy-ethyl) diisobutylketimine, cyanomethyl, or 2-cyanoethyl methacrylate; halogenated alkyl methacrylates such as chloromethyl, 1,3-dichloro-2-propyl, 4-bromophenyl, 2-bromoethyl, 2,3-dibromopropyl, or 2-iodoethyl methacrylate; sulfur-containing methacrylates such as methylthiol, butylthiol, ethylsulfonylethyl, ethylsulfinylethyl, thiocyanatomethyl, 4-thiocyanatobutyl, methylsulfinylmethyl, 2-dodecylthioethyl methacrylate, or bis(methacryloyloxyethyl) sulfide; phosphorous-boron-silicon-containing methacrylates such as 2-(ethylenephosphito)propyl, dimethylphosphinomethyl, dimethylphosphonoethyl, diethylphosphatoethyl, 2-(dimethylphosphato)propyl, 2-(dibutylphosphono)ethyl methacrylate, diethyl methacryloylphosphonate, dipropyl methacryloyl phosphate, diethyl methacryloyl phosphite, 2-methacryloyloxyethyl diethyl phosphite, 2,3-butylene methacryloyl-oxyethyl borate, or methyldiethoxymethacryloyloxyethoxysilane. Said methacrylic amides and nitriles can be selected from a group consisting of N-methylmethacrylamide, N-isopropylmethacrylamide, N-phenylmethacrylamide, N-(2-hydroxyethyl)methacrylamide, 1-methacryloylamido-2-methyl-2-propanol, 4-methacryloylamido-4-methyl-2-pentanol, N-(methoxymethyl)methacrylamide, N-(dimethylaminoethyl)methacrylamide, N-(3-dimethylaminopropyl)methacrylamide, N-acetylmethacrylamide, N-methacryloylmaleamic acid, methacryloylamidoacetonitrile, N-(2-cyanoethyl)methacrylamide, 1-methacryloylurea, N-phenyl-N-phenylethylmethacrylamide, N-(3-dibutylaminopropyl)methacrylamide, N,N-diethylmethacrylamide, N-(2-cyanoethyl)-N-methylmethacrylamide, N,N-bis(2-diethylaminoethyl)methacrylamide, N-methyl-N-phenylmethacrylamide, N,N′-methylenebismethacrylamide, N,N′-ethylenebismethacrylamide, or N-(diethylphosphono)methacrylamide. Said other optional monomers can be selected from a group consisting of acrolein, acrylic anhydride, acrylonitrile, acryloyl chloride, methacrolein, methacrylonitrile, methacrylic anhydride, methacrylic acetic anhydride, methacryloyl chloride, methacryloyl bromide, itaconic acid, butadiene, vinyl chloride, vinylidene chloride, or vinyl acetate.

As used herein, aminoplast resin refers to a type of amino resin made from a nitrogen-containing substance and formaldehyde, wherein the nitrogen-containing substance includes melamine, urea, benzoguanamine and glycoluril. Also as used herein, melamine resins are amino resins made from melamine and formaldehyde. Melamine resins are known under various trade names, including but not limited to CYMEL™, BEETLE™, DYNOMIN™, BECKAMINE™, UFR™, BAKELITE™, ISOMIN™, MELAICAR™, MELBRITE™, MELMEX™, MELOPAS™, RESART™, and ULTRAPAS™. As used herein, urea resins are amino resins made from urea and formaldehyde. Urea resins are known under various trade names, including but not limited to CYMEL™, BEETLE™, UFRM, DYNOMIN™, BECKAMINE™, and AMIREME™. As used herein, benzoguanamine resins are amino resins made from benzoguanamine and formaldehyde. Benzoguanamine resins are known under various trade names, including but not limited to CYMEL™, BEETLE™, and UFORMITE™. As used herein, glycoluril resins are amino resins made from glycoluril and formaldehyde. Glycoluril resins are known under various trade names, including but not limited to CYMEL™, and POWDERLINK™. The aminoplast resins can be highly alkylated or partially alkylated.

In embodiments, the melamine resin has a generic formula of: 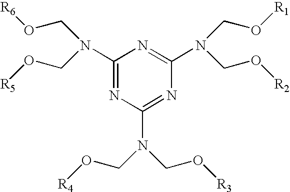
in which R₁, R₂, R₃, R₄, R₅ and R₆ each independently represents a hydrogen atom or an alkyl chain with 1 to 8 carbon atoms, or with 1 to 4 carbon atoms. In embodiments, the melamine resin is water-soluble, dispersible or indispersible. In various embodiments, the melamine resin can be highly alkylated/alkoxylated, partially alkylated/alkoxylated, or mixed alkylated/alkoxylated. In various embodiments, the melamine resin can be methylated, n-butylated or isobutylated. Examples of the melamine resin include highly methylated melamine resins such as CYME™L 350, 9370; methylated high imino melamine resins (partially methylolated and highly alkylated) such as CYMEL™ 323, 327; partially methylated melamine resins (highly methylolated and partially methylated) such as CYMEL™ 373, 370; high solids mixed ether melamine resins such as CYMEL™ 1130, 324; n-butylated melamine resins such as CYMEL™ 1151, 615; n-butylated high imino melamine resins such as CYMEL™ 1158; iso-butylated melamine resins such as CYMEL™ 255-10. CYMEL™ melamine resins are commercially available from CYTEC. In embodiments, the melamine resin may be selected from methylated formaldehyde-melamine resin, methoxymethylated melamine resin, ethoxymethylated melamine resin, propoxymethylated melamine resin, butoxymethylated melamine resin, hexamethylol melamine resin, alkoxyalkylated melamine resins such as methoxymethylated melamine resin, ethoxymethylated melamine resin, propoxymethylated melamine resin, butoxymethylated melamine resin, and mixtures thereof.

In embodiments, the urea resin has a generic formula of: 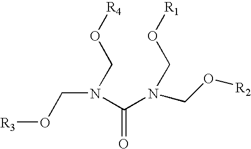
in which R₁, R₂, R₃, and R₄ each independently represents a hydrogen atom or an alkyl chain with 1 to 8 carbon atoms, or with 1 to 4 carbon atoms. In embodiments, the urea resin is water-soluble, dispersible or indispersible. In various embodiments, the urea resin can be highly alkylated/alkoxylated, partially alkylated/alkoxylated, or mixed alkylated/alkoxylated. In various embodiments, the urea resin can be methylated, n-butylated or isobutylated. Examples of the urea resin include methylated urea resins such as CYMEL™ U-65, U-382; n-butylated urea resins such as CYMEL™ U-1054, UB-30-B; iso-butylated urea resins such as CYMEL™ U-662, UI-19-I. CYMEL™ urea resins are commercially available from CYTEC.

In embodiments, the benzoguanamine resin has a generic formula of: 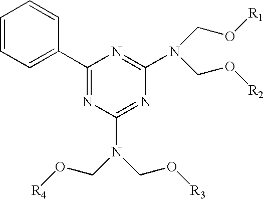
in which R₁, R₂, R₃, and R₄ each independently represents a hydrogen atom or an alkyl chain with 1 to 8 carbon atoms, or with 1 to 4 carbon atoms. In embodiments, the benzoguanamine resin is water-soluble, dispersible or indispersible. In various embodiments, the benzoguanamine resin can be highly alkylated/alkoxylated, partially alkylated/alkoxylated, or mixed alkylated/alkoxylated. In various embodiments, the benzoguanamine resin can be methylated, n-butylated or isobutylated. Examples of the benzoguanamine resin include CYMEL™ 659, 5010, 5011. CYMEL™ benzoguanamine resins are commercially available from CYTEC.

In embodiments, the glycoluril resin has a generic formula of: 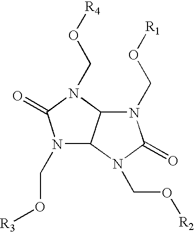
in which R₁, R₂, R₃, and R₄ each independently represents a hydrogen atom or an alkyl chain with 1 to 8 carbon atoms, or with 1 to 4 carbon atoms. In embodiments, the glycoluril resin is water-soluble, dispersible or indispersible. In various embodiments, the glycoluril resin can be highly alkylated/alkoxylated, partially alkylated/alkoxylated, or mixed alkylated/alkoxylated. In various embodiments, the glycoluril resin can be methylated, n-butylated or isobutylated. Examples of the glycoluril resin include CYMEL™ 1170, 1171. CYMEL™ glycoluril resins are commercially available from CYTEC.

In embodiments, a ratio of the styrene acrylic copolymer to the aminoplast resin in the co-resin can be about 1/99 to about 99/1. In various embodiments, the ratio of the styrene acrylic copolymer to the aminoplast resin in the co-resin can be about 20/80 to about 80/20. In various embodiments, the weight ratio of the styrene acrylic copolymer to the aminoplast resin in the co-resin can be about 30/70 to about 70/30.

In embodiments, the metal oxides may be selected from, for example, ZnO, SnO₂, TiO₂, Al₂O₃, SiO₂, ZrO₂, In₂O₃, MoO₃, and a complex oxide thereof. In various embodiments, the metal oxids have a powder volume resistivity varying from about 10⁴ to about 10¹⁰ Ωcm at a 100 kg/cm² loading pressure, 50% humidity, and room temperature. In various embodiments, the metal oxides are TiO₂. In various embodiments, TiO₂ can be either surface treated or untreated. Surface treatments include, but are not limited to aluminum laurate, alumina, zirconia, silica, silane, methicone, dimethicone, sodium metaphosphate, and the like and mixtures thereof. Examples of TiO₂ include STR-60N (no surface treatment and powder volume resisitivity of approximately 9×10⁵ Ωcm) (available from Sakai Chemical Industry Co., Ltd.), FTL-100 (no surface treatment and powder volume resisitivity of approximately 3×10⁵ Ωcm) (available from Ishihara Sangyo Laisha, Ltd.), STR-60 (Al₂O₃ coated and powder volume resisitivity of approximately 4×10⁶ Ωcm) (available from Sakai Chemical Industry Co., Ltd.), TTO-55N (no surface treatment and powder volume resisitivity of approximately 5×10⁵ Ωcm) (available from Ishihara Sangyo Laisha, Ltd.), TTO-55A (Al₂O₃ coated and powder volume resisitivity of approximately 4×10⁷ Ωcm) (available from Ishihara Sangyo Laisha, Ltd.), MT-150W (sodium metaphosphated coated and powder volume resisitivity of approximately 4×10⁴ Ωcm) (available from Tayca), and MT-150AW (no surface treatment and powder volume resisitivity of approximately 1×10⁵ Ωcm) (available from Tayca). In various embodiments, a weight ratio of the metal oxide to the co-resin can be from about 20/80 to about 80/20, or from about 40/60 to about 70/30.

In embodiments, the electrophotographic imaging member binder may optionally contain an acid catalyst. In various embodiments, the acid catalyst can be a para-toluene sulfonic acid. In various embodiments, the acid catalyst is CYCAT™ 4040 commercially available from CYTEC. In various embodiments, the acid catalyst is an amine neutralized para-toluene sulfonic acid. In various embodiments, the acid catalyst is NACURE™ 2107 commercially available from King Industries. In various embodiments, the acid catalyst is an amine neutralized phenyl acid phosphate. In various embodiments, the acid catalyst is NACURE™ 4575 commercially available from King Industries. In various embodiments, the acid catalyst is an amine neutralized dinonylnaphthalenedisulfonic acid. In various embodiments, the acid catalyst is NACURE™ 3525 commercially available from King Industries. In various embodiments, the acid catalyst is used to cure the styrene acrylic copolymer/aminoplast co-resin. In various embodiments, the styrene acrylic copolymer/aminoplast co-resin is cured at temperatures from about 80° C. to about 200° C., or from about 120° C. to about 180° C. for a period of from about 10 minutes to about 60 minutes, or from about 20 minutes to about 45 minutes. In embodiments, the acid catalyst can be present in an amount of from about 0% to about 1.0%, or from about 0.1% to about 0.4% by weight of a total weight of the undercoat layer.

In various embodiments, the undercoat layer may optionally contain a light scattering particle. In various embodiments, the light scattering particle has a refractive index different from the binder and has a number average particle size greater than about 0.8 μm. Examples of the light scattering particle include, but are not limited to, inorganic materials such as amorphous silica, silicone ball and minerals. Typical minerals include, for example, metal oxides, silicates, carbonates, sulfates, iodites, hydroxides, chlorides, fluorides, phosphates, chromates, clay, sulfur and the like. In various embodiments, the light scattering particle is amorphous silica P-100, commercially available from Espirit Chemical Co. In various embodiments, the light scattering particle can be present in an amount of from about 0% to about 10%, or from about 2% to about 5% by weight of a total weight of the undercoat layer.

Electrophotographic Imaging Member

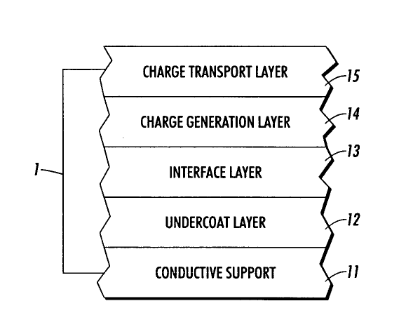

FIG. 1 is a cross-sectional view schematically showing an embodiment of an electrophotographic imaging member. The electrophotographic imaging member 1 shown in FIG. 1 contains separate charge generation layer 14 and charge transport layer 15. In the embodiment illustrated in FIG. 1, an undercoat layer 12 and an optional interface layer 13 are included in the electrophotographic imaging member 1. In embodiments, the undercoat layer 12 is interposed between the charge generation layer 14 and the conductive support 11. In embodiments, the interface layer is interposed between the undercoat layer 12 and the charge generation layer 14. In embodiments, the undercoat layer is located between the conductive support and the charge generation layer, without any intervening layers. In various embodiments, additional layers, such as an interface layer or an adhesive layer, may be present and located between the undercoat layer and the charge generation layer, and/or between the conductive support and the undercoat layer.

In embodiments, the conductive support 11 may include, for example, a metal plate, a metal drum or a metal belt using a metal such as aluminum, copper, zinc, stainless steel, chromium, nickel, molybdenum, vanadium, indium, gold or a platinum, or an alloy thereof; and paper or a plastic film or belt coated, deposited or laminated with a conductive polymer, a conductive compound such as indium oxide, a metal such as aluminum, palladium or gold, or an alloy thereof. Further, surface treatment such as anodic oxidation coating, hot water oxidation, chemical treatment, coloring or diffused reflection treatment such as graining can also be applied to a surface of the support 11.

In embodiments, the undercoat layer 12 contains metal oxides and a co-resin comprising a styrene acrylic copolymer and a melamine resin. In various embodiments, the styrene acrylic copolymer is selected from JONCRYL 500, 507, 550, and 580, commercially available from Johnson Polymers. In various embodiments, the styrene acrylic copolymer is JONCRYL 580. In various embodiments, the melamine resin is selected from CYMEL™ 350, 327, 323, 327, and 303, commercially available from CYTEC. In various embodiments, the melamine resin is CYMEL™ 323. In embodiments, a ratio of the styrene acrylic copolymer to the melamine resin in the binder is about 1/99 to about 99/1. In various embodiments, the metal oxides are TiO₂. For example, in various embodiments, the TiO₂ is MT-150W, commercially available from Tayca. In various embodiments, the metal oxides have a powder volume resistivity varying from about 10⁴ to about 10¹⁰ Ωcm at a 100 kg/cm² loading pressure, 50% humidity, and room temperature. In various embodiments, the weight ratio of the metal oxide to the co-resin is from about 20/80 to about 80/20.

In embodiments, the undercoat layer 12 may also contain one or more conventional binders. Examples of conventional binders include, but are not limited to, polyamides, vinyl chlorides, vinyl acetates, phenols, polyurethanes, melamines, benzoguanamines, polyimides, polyethylenes, polypropylenes, polycarbonates, polystyrenes, acrylics, methacrylics, vinylidene chlorides, polyvinyl acetals, epoxys, silicones, vinyl chloride-vinyl acetate copolymers, polyvinyl alcohols, polyesters, polyvinyl butyrals, nitrocelluloses, ethyl celluloses, caseins, gelatins, polyglutamic acids, starches, starch acetates, amino starches, polyacrylic acids, polyacrylamides, zirconium chelate compounds, titanyl chelate compounds, titanyl alkoxide compounds, organic titanyl compounds, silane coupling agents, and combinations thereof.

In embodiments, the undercoat layer 12 may optionally contain an acid catalyst. In various embodiments, the acid catalyst is a para-toluene sulfonic acid. In various embodiments, the acid catalyst is CYCAT™ 4040 commercially available from CYTEC. In embodiments, the acid catalyst is present in an amount of about 0% to about 1.0% by weight of a total weight of the undercoat layer.

In embodiments, the undercoat layer 12 may contain an optional light scattering particle. In various embodiments, the light scattering particle has a refractive index different from the binder and has a number average particle size greater than about 0.8 μm. In various embodiments, the light scattering particle is amorphous silica P-100 commercially available from Espirit Chemical Co. In various embodiments, the light scattering particle is present in an amount of about 0% to about 10% by weight of a total weight of the undercoat layer.

In embodiments, the undercoat layer 12 may contain various colorants. In various embodiments, the undercoat layer may contain organic pigments and organic dyes, including, but not limited to, azo pigments, quinoline pigments, perylene pigments, indigo pigments, thioindigo pigments, bisbenzimidazole pigments, phthalocyanine pigments, quinacridone pigments, quinoline pigments, lake pigments, azo lake pigments, anthraquinone pigments, oxazine pigments, dioxazine pigments, triphenylmethane pigments, azulenium dyes, squalium dyes, pyrylium dyes, triallylmethane dyes, xanthene dyes, thiazine dyes, and cyanine dyes. In various embodiments, the undercoat layer 12 may include inorganic materials, such as amorphous silicon, amorphous selenium, tellurium, a selenium-tellurium alloy, cadmium sulfide, antimony sulfide, titanium oxide, tin oxide, zinc oxide, and zinc sulfide, and combinations thereof.

In embodiments, the undercoat layer 12 may be formed between the electroconductive support and the charge generation layer. The undercoat layer is effective for blocking leakage of charge from the electroconductive support to the charge generation layer and/or for improving the adhesion between the electroconductive support and the charge generation layer. In embodiments, one or more additional layers may exist between the undercoat layer 12 and the charge generation layer.

In embodiments, the undercoat layer 12 can be coated onto the conductive support 11 from a suitable solvent. Suitable solvents include, but are not limited to, xylene/1-butanol/MEK, N,N-dimethyl formamide, N,N-dimethyl acetamide, dimethyl sulfoxide, tetrahydrofuran, dichloromethane, xylene, toluene, methanol, ethanol, 1-butanol, isobutanol, methyl ethyl ketone, methyl isobutyl ketone, and mixtures thereof.

In embodiments, the undercoat layer 12 may be coated onto the conductive substrate 11 using various coating methods. Suitable coating methods include, but are not limited to, blade coating, wire bar coating, spray coating, dip coating, bead coating, air knife coating or curtain coating is employed.

In embodiments, the thickness of the undercoat layer 12 is from about 0.1 μm to 30 μm, or from about 2 μm to 20 μm, or from about 4 μm to 15 μm. In embodiments, electrophotographic imaging members contain undercoat layer s having a thickness of from about 0.1 μm to 30 μm, or from about 2 μm to 20 μm, or from about 4 μm to 15 μm.

In embodiments, the electrophotographic imaging member 1 may optionally include an interface layer 13. In various embodiments, the interface layer 13 may contain one or more conventional components. Examples of conventional components include, but are not limited to, polyesters, polyamides, poly(vinyl butyral), poly(vinyl alcohol), polyurethane and polyacrylonitrile. In various embodiments, the interface layer may also contain conductive and nonconductive particles, such as zinc oxide, titanium dioxide, silicon nitride, carbon black, and the like. In embodiments, the interface layer 13 may be coated onto a substrate using various coating methods. Suitable coating methods include, but are not limited to, blade coating, wire bar coating, spray coating, dip coating, bead coating, air knife coating or curtain coating is employed. In embodiments, the thickness of the interface layer is from about 0.001 μm to about 5 μm. In various embodiments, the thickness of the interface layer is less than about 1.0 μm. In various embodiments, the thickness of the interface layer is about 0.5 μm.

In embodiments, the charge generation layer 14 can be formed by applying a coating solution containing the charge generation substance(s) and a binding resin, and further fine particles, an additive, and other components.

In embodiments, binding resins used in the charge generation layer 14 may include polyvinyl acetal resins, polyvinyl formal resins or a partially acetalized polyvinyl acetal resins in which butyral is partially modified with formal or acetoacetal, polyamide resins, polyester resins, modified ether-type polyester resins, polycarbonate resins, acrylic resins, polyvinyl chloride resins, polyvinylidene chlorides, polystyrene resins, polyvinyl acetate resins, vinyl chloride-vinyl acetate copolymers, silicone resins, phenol resins, phenoxy resins, melamine resins, benzoguanamine resins, urea resins, polyurethane resins, poly-N-vinylcarbazole resins, polyvinylanthracene resins and polyvinylpyrene resins. These can be used either alone or as a combination of two or more of them. In embodiments, the solvents used in preparing the charge generation layer coating solution may include organic solvents such as methanol, ethanol, n-propanol, n-butanol, benzyl alcohol, methyl cellosolve, ethyl cellosolve, acetone, methyl ethyl ketone, cyclohexanone, chlorobenzene, methyl acetate, n-butyl acetate, dioxane, tetrahydrofuran, methylene chloride and chloroform, mixtures of two or more of thereof, and the like. In embodiments, the charge generation layer 14 may include various charge generation substances, including, but not limited to, various organic pigments and organic dyes such as an azo pigment, a quinoline pigment, a perylene pigment, an indigo pigment, a thioindigo pigment, a bisbenzimidazole pigment, a phthalocyanine pigment, a quinacridone pigment, a quinoline pigment, a lake pigment, an azo lake pigment, an anthraquinone pigment, an oxazine pigment, a dioxazine pigment, a triphenylmethane pigment, an azulenium dye, a squalium dye, a pyrylium dye, a triallylmethane dye, a xanthene dye, a thiazine dye and cyanine dye; and inorganic materials such as amorphous silicon, amorphous selenium, tellurium, a selenium-tellurium alloy, cadmium sulfide, antimony sulfide, zinc oxide and zinc sulfide. The charge generation substances may be used either alone or as a combination of two or more of them. In embodiments, the ratio of the charge generation substance to the binding resin is within the range of 5:1 to 1:2 by volume. In embodiments, the charge generation layer 14 is formed by various forming methods, including but not limited to, dip coating, roll coating, spray coating, rotary atomizers, and the like. In various embodiments, the charge generation layer 14 is formed by the vacuum deposition of the charge generation substance(s), or by the application of a coating solution in which the charge generation substance is dispersed in an organic solvent containing a binding resin. In embodiments, the deposited coating may be effected by various drying methods, including, but not limited to, oven drying, infra-red radiation drying, air drying and the like. In embodiments, a stabilizer such as an antioxidant or an inactivating agent can be added to the charge generation layer 14. The antioxidants include, for example, antioxidants such as phenolic, sulfur, phosphorus and amine compounds. The inactivating agents include bis(dithiobenzyl)nickel and nickel di-n-butylthiocarbamate. The charge transport layer 14 may further contain an additive such as a plasticizer, a surface modifier, and an agent for preventing deterioration by light.

In embodiments, the charge transport layer 15 can be formed by applying a coating solution containing the charge transport substance(s) and a binding resin, and further fine particles, an additive, and other components. In embodiments, binding resins used in the charge transport layer 15 are high molecular weight polymers that can form an electrical insulating film. Examples of these binding resins include, but are not limited to, polyvinyl acetal resins, polyamide resins, cellulose resins, phenol resins, polycarbonates, polyesters, methacrylic resins, acrylic resins, polyvinyl chlorides, polyvinylidene chlorides, polystyrenes, polyvinyl acetates, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazoles, polyvinyl butyrals, polyvinyl formals, polysulfones, caseins, gelatins, polyvinyl alcohols, phenol resins, polyamides, carboxymethyl celluloses, vinylidene chloride-based polymer latexes, and polyurethanes. In embodiments, the charge transport layer 15 may include various activating compounds that, as an additive dispersed in electrically inactive polymeric materials, makes these materials electrically active. These compounds may be added to polymeric materials which are incapable of supporting the injection of photogenerated holes from the charge generation material and incapable of allowing the transport of these holes therethrough. This will convert the electrically inactive polymeric material to a material capable of supporting the injection of photogenerated holes from the charge generation material and capable of allowing the transport of these holes through the active layer in order to discharge the surface charge on the active layer. In embodiments, the charge transport layer 15 is from about 25 percent to about 75 percent by weight of at least one charge transporting aromatic amine compound, and about 75 percent to about 25 percent by weight of a polymeric film forming resin in which the aromatic amine is soluble. In embodiments, low molecular weight charge transport substances may include, but are not limited to, pyrenes, carbazoles, hydrazones, oxazoles, oxadiazoles, pyrazolines, arylamines, arylmethanes, benzidines, thiazoles, stilbenes, and butadiene compounds. Further, high molecular weight charge transport substances may include, but are not limited to, poly-N-vinylcarbazoles, poly-N-vinylcarbazole halides, polyvinyl pyrenes, polyvinylanthracenes, polyvinylacridines, pyrene-formaldehyde resins, ethylcarbazole-formaldehyde resins, triphenylmethane polymers, and polysilanes. In embodiments, the charge transport layer 15 may contain an additive such as a plasticizer, a surface modifier, an antioxidant or an agent for preventing deterioration by light. In embodiments, the charge transport layer 15 may be mixed and applied to a coated or uncoated substrate by various methods, including, but not limited to, spraying, dip coating, roll coating, wire wound rod coating, and the like. In embodiments, the charge transport layer 15 may be dried by various drying method, including, but not limited to, oven drying, infra-red radiation drying, air drying and the like.

In embodiments, an overcoat layer may be applied to improve resistance to abrasion. The overcoat layer may contain a resin, a silicon compound and metal oxide nanoparticles. The overcoat layer may further contain a lubricant or fine particles of a silicone oil or a fluorine material, which can also improve lubricity and strength. In embodiments, the thickness of the overcoat layer is from 0.1 to 10 μm, from 0.5 to 7 μm, orfrom 1.5 to 3.5 μm.

In embodiments, an anti-curl back coating may be applied to provide flatness and/or abrasion resistance where a web configuration photoreceptor is fabricated. An example of an anti-curl backing layer is described in U.S. Pat. No. 4,654,284, incorporated herein by reference in its entirety.

All the patents and applications referred to herein are hereby specifically, and totally incorporated herein by reference in their entirety in the instant specification.

It will be appreciated that several of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

### EXAMPLES

The examples set forth herein below and are illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

### Example I

An undercoat layer dispersion was prepared as follows: in a 120 ml glass bottle, 13.5 grams of TiO₂ MT-150W (available from Tayca Co.), 4.5 grams of JONCRYL 580 (available from Johnson Polymers LLC), 4.5 grams of CYMEL 323 (80 wt % in isopropanol) (available from Cytec Industries Inc.) and 30 grams of MEK were mixed with 150 grams of 2 mm ZrO₂ beads. The ball milling was carried out for 30 hours under 200 rpm. The dispersion was filtered through a 20 μm Nylon cloth filter, and the final dispersion was measured for S_{w}˜15 m²/g.

An experimental device was prepared by coating the new undercoat layer at 5 μm at a curing condition of 160° C./30 min. A charge generation layer comprising chlorogallium phthalocyanine (B) was disposed on the undercoat layer at a thickness of about 0.2 μm. The charge generation layer coating dispersion as prepared as follows: 2.7 grams of chlorogallium phthalocyanine (CIGaPc) Type B pigment was mixed with 2.3 grams of polymeric binder (carboxyl-modified vinyl copolymer, VMCH, Dow Chemical Company), 15 grams of n-butyl acetate and 30 grams of xylene. The mixture was milled in an ATTRITOR mill with about 200 grams of 1 mm Hi-Bea borosilicate glass beads for about 3 hours. The dispersion was filtered through a 20-μm nylon cloth filter, and the solid content of the dispersion was diluted to about 6 weight percent. Subsequently, a 29 μm charge transport layer was coated on top of the charge generation layer from a dispersion prepared from N,N′-diphenyl-N,N-bis(3-methylphenyl)-1,1′-biphenyl-4,4′-diamine (5.38 grams), a film forming polymer binder PCZ 400 [poly(4,4′-dihydroxy-diphenyl-1-1-cyclohexane, M_{w}=40,000)] available from Mitsubishi Gas Chemical Company, Ltd. (7.13 grams), and PTFE POLYFLON™ L-2 microparticle (1 gram) available from Daikin Industries dissolved/dispersed in a solvent mixture of 20 grams of tetrahydrofuran (THF) and 6.7 grams of toluene via a CAVIPRO™ 300 nanomizer (Five Star Technology, Cleveland, Ohio). The charge transport layer was dried at about 120° C. for about 40 minutes.

### Comparative Example I

A comparative undercoat layer dispersion was prepared in the same manner as the undercoat layer in Example I except that acrylic polymer PARALOID AT-400 (available from Rohm and Haas) was incorporated in place of the styrene acrylic copolymer (JONCRYL 580).

The comparative device was prepared in the same manner as the experimental device.

The above prepared photoreceptor devices were tested in a scanner set to obtain photo-induced discharge characteristic (PIDC) curves, sequenced at one charge-erase cycle followed by one charge-expose-erase cycle, wherein the light intensity was incrementally increased with cycling to produce a series of PIDC curves from which the photosensitivity and surface potentials at various exposure intensities were measured. Additional electrical characteristics were obtained by a series of charge-erase cycles with incrementing surface potential to generate several voltages versus charge density curves. The scanner was equipped with a scorotron set to a constant voltage charging at various surface potentials. The devices were tested at surface potentials of about 500 and about 700 volts with the exposure light intensity incrementally increased by means of regulating a series of neutral density filters. The exposure light source was a 780-nanometer light emitting diode. The aluminum drum was rotated at a speed of about 61 revolutions per minute to produce a surface speed of about 122 millimeters per second. The xerographic simulation was completed in an environmentally controlled light tight chamber at ambient conditions (about 50% relative humidity and about 22° C.).

Very similar PIDC curves were observed for both photoreceptor devices, thus the new undercoat layer, containing the styrene acrylic copolymer, performs very similarly to a comparative undercoat layer from the point of view of PIDC. The experimental device showed normal electrical propertied with similar residual voltage and charge acceptance to that of reference device. The Vdep, Vlow, dV/dX, Verase, and dark decay all suggest the new undercoat layer is functioning properly.

The above photoreceptor drums were then acclimated for 24 hours before testing J-zone conditions (70 F./10% RH) in a Copeland Work centre Pro 3545 machine using K station at t=0 and t=500 print count. Run-ups from t=0 to t=500 prints for all devices were done in one of the CYM color stations. Ghosting levels were measured against TSIDU SIR scale. Smaller the ghosting grade, better the imaging quality.

The ghosting tests revealed that the new undercoat layer containing styrene acrylic copolymer exhibits even lower ghosting levels than layers containing only acrylic polymer in J zone.

The new undercoat layer has ghosting of about 0 at t=0 and about −1 at t=500, while the comparative undercoat layer has ghosting of about 0 at t=0 and about −2 at t=500. The new undercoat layer exhibits significantly better ghosting levels than those typically observed from regular three-component devices, under the same stress conditions. Therefore, incorporation of styrene acrylic copolymers and aminoplast resins in combination with a metal oxide, such as titanium oxide, in the undercoat layer significantly improves print quality such as ghosting. The testing results show that this undercoat layer formulation exhibits essentially zero or low ghosting images even at the most severe testing condition.

What is claimed is:

1. An electrophotographic imaging member, comprising:
a substrate;
an undercoat layer disposed on the substrate, wherein the undercoat layer further comprises
a styrene acrylic copolymer,
an aminoplast resin, and
a metal oxide dispersed therein; and
at least one imaging layer formed on the undercoat layer.

2. The electrophotographic imaging member of claim 1, wherein the styrene acrylic copolymers are copolymers selected from the group consisting of styrene, acrylic, derivatives of acrylic, methacrylic acid, derivatives of methacrylic acid, other optional monomers and mixtures thereof.

3. The electrophotographic imaging member of claim 2, wherein the derivatives of acrylic and the derivatives of methacrylic acid are selected from the group consisting of n-alkyl acrylates, secondary and branched-chain alkyl acrylates, olefinic acrylates, aminoalkyl acrylates, ether acrylates, cycloalkyl acrylates, halogenated alkyl acrylates, glycol acrylates and diacrylates, alkyl methacrylates, unsaturated alkyl methacrylates, cycloalkyl methacrylates, aryl methacrylates, hydroxyalkyl methacrylates, ether methacrylates, oxiranyl methacrylates, aminoalkyl methacrylates, glycol dimethacrylates, trimethacrylates, carbonyl-containing methacrylates, other nitrogen-containing methacrylates, halogenated alkyl methacrylates, sulfur-containing methacrylates, phosphorous-boron-silicon-containing methacrylates, N-methylmethacrylamide, N-isopropylmethacrylamide, N-phenylmethacrylamide, N-(2-hydroxyethyl)methacrylamide, 1-methacryloylamido-2-methyl-2-propanol, 4-methacryloylamido-4-methyl-2-pentanol, N-(methoxymethyl)methacrylamide, N-(dimethylaminoethyl)methacrylamide, N-(3-dimethylaminopropyl)methacrylamide, N-acetylmethacrylamide, N-methacryloylmaleamic acid, methacryloylamidoacetonitrile, N-(2-cyanoethyl)methacrylamide, 1-methacryloylurea, N-phenyl-N-phenylethylmethacrylamide, N-(3-dibutylaminopropyl)methacrylamide, N,N-diethylmethacrylamide, N-(2-cyanoethyl)-N-methylmethacrylamide, N,N-bis(2-diethylaminoethyl)methacrylamide, N-methyl-N-phenylmethacrylamide, N,N′-methylenebismethacrylamide, N,N′-ethylenebismethacrylamide, or N-(diethylphosphono)methacrylamide, and mixtures thereof.

4. The electrophotographic imaging member of claim 2, wherein the other optional monomers are selected from the group consisting of acrolein, acrylic anhydride, acrylonitrile, acryloyl chloride, methacrolein, methacrylonitrile, methacrylic anhydride, methacrylic acetic anhydride, methacryloyl chloride, methacryloyl bromide, itaconic acid, butadiene, vinyl chloride, vinylidene chloride, or vinyl acetate, and mixtures thereof.

5. The electrophotographic imaging member of claim 1, wherein the aminoplast resins are amino resins comprising nitrogen-containing substance and formaldehyde, the nitrogen-containing substance being selected from the group consisting of melamine, urea, benzoguanamine, glycoluril, and mixtures thereof.

6. The electrophotographic imaging member of claim 1, wherein the metal oxide is selected from the group consisting of titanium oxide, zinc oxide, tin oxide, aluminum oxide, silicon oxide, zirconium oxide, indium oxide, molybdenum oxide, and mixtures thereof.

7. The electrophotographic imaging member of claim 1, wherein the metal oxide has a powder volume resistivity varying from about 10⁴ to about 10¹⁰ Ωcm at a 100 kg/cm² loading pressure, 50% humidity, and room temperature.

8. The electrophotographic imaging member of claim 1, wherein the metal oxide is titanium oxide.

9. The electrophotographic imaging member of claim 1, wherein the least one imaging layer is a charge transport layer.

10. The electrophotographic imaging member of claim 1, wherein thickness of the undercoat layer is from about 0.1 Ωm to about 30 Ωm.

11. The electrophotographic imaging member of claim 1, wherein the weight ratio of the metal oxide to the co-resin is from about 20/80 to about 80/20, or from about 40/60 to about 70/30.

12. The electrophotographic imaging member of claim 1, wherein the weight ratio of the styrene acrylic copolymer to the aminoplast resin in the co-resin is from about 1/99 to about 99/1, or from about 30/70 to about 70/30.

13. The electrophotographic imaging member of claim 1 further including an optional crosslinking agent in the undercoat layer, the crosslinking agent being selected from the group consisting of p-toulenesulfonic acid, naphthalenesulfonic acid, phthalic acid, maleic acid, amine salts of inorganic acids, ammonium salts of inorganic acids, and mixtures thereof.

14. An electrophotographic imaging member, comprising:
a substrate;
an undercoat layer disposed on the substrate, wherein the undercoat layer further comprises
a styrene acrylic copolymer,
a melamine-formaldehyde resin, and
titanium oxide dispersed therein; and
a charge transport layer formed on the undercoat layer.

15. An image forming apparatus for forming images on a recording medium comprising:
a) an electrophotographic imaging member having a charge retentive-surface to receive an electrostatic latent image thereon, wherein the electrophotographic imaging member comprises
a substrate,
an undercoat layer disposed on the substrate, wherein the undercoat layer further comprises
a styrene acrylic copolymer,
an aminoplast resin, and
a metal oxide dispersed therein, and
at least one imaging layer formed on the undercoat layer;
b) a development component adjacent to the charge-retentive surface for applying a developer material to the charge-retentive surface to develop the electrostatic latent image to form a developed image on the charge-retentive surface;
c) a transfer component adjacent to the charge-retentive surface for transferring the developed image from the charge-retentive surface to a copy substrate; and
d) a fusing component adjacent to the copy substrate for fusing the developed image to the copy substrate.

16. The image forming apparatus of claim 14, wherein the aminoplast resins are selected from the group consisting of melamine-formaldehyde resin, urea-formaldehyde resin, benzoguanamine-formaldehyde resin, glycoluril-formaldehyde resin, and mixtures thereof.

17. The image forming apparatus of claim 14, wherein the metal oxide is titanium oxide.

18. The image forming apparatus of claim 14, wherein the weight ratio of the metal oxide to the co-resin is from about 20/80 to about 80/20, or from about 40/60 to about 70/30.

19. The image forming apparatus of claim 14, wherein the weight ratio of the styrene acrylic copolymer to the aminoplast resin in the co-resin is from about 1/99 to about 99/1, or from about 30/70 to about 70/30.

20. The image forming apparatus of claim 14, wherein thickness of the undercoat layer is from about 0.1 μm to about 30 μm.
